(19) United States
(12) Patent Application Publication
(10) Pub. No.: US 2011/0286779 A1
(43) Pub. Date: Nov. 24, 2011

(54) ELECTROPHOTOGRAPHIC PRINT BINDING METHOD AND SYSTEM

(76) Inventors: Brian J. Kwarta, Pittsford, NY (US); James D. Shifley, Spencerport, NY (US); Donald S. Rimai, Webster, NY (US)

(21) Appl. No.: 12/786,042

(22) Filed: May 24, 2010

(51) Int. Cl. G03G 15/00

(52) U.S. Cl. 399/409

(57) ABSTRACT

Methods and printers are provided for forming bound electrophotographic prints are provided. In one aspect, the method comprises the steps of applying a toner to a receiver to form a toner image with having toner in a binding area and in an image area. The binding area is proximate to a binding edge of the receiver and the image area that is separated from the binding area by an separation area; (printers). The toner image is fused to form a print, and a sheet and the prints are stacked with the toner in the binding area of the print confronting the sheet along a binding edge of the sheet. Heat is applied at the binding edges to cause the toner in the binding area to fuse for a second time. A residual portion of the applied heat heats the separation area but the separation area does not heat the image area to an extent sufficient to fuse toner in the image area.

### CROSS REFERENCE TO RELATED APPLICATIONS

This application relates to commonly assigned, copending U.S. application Ser. No. ______ (Docket No. 96227° RRS), filed ______, entitled: “ELECTROPHOTOGRAPHIC PRINT BINDING METHOD”, and U.S. application Ser. No. ______(96313RRS), filed ______, entitled: “ELECTROPHOTOGRAPHIC PRINT BINDING SYSTEM”, hereby incorporated by reference.

### FIELD OF THE INVENTION

This invention relates to methods and apparatuses that are used to bind electrophotographic prints.

### BACKGROUND OF THE INVENTION

Electrophotographic printing systems typically generate prints that are highly valued for their excellent image quality and durability. Such prints become even more valid when combined to form bound products such as books, cards, photobooks, and the like. Accordingly electrophotographic printing systems that can automatically bring prints together are highly desirable.

However, it is not a simple task to bind a stack of pages to make bound product. Conventionally this is done using staples, stitches, or adhesives as is shown for example in JP 09-109587 entitled “Document Binding Apparatus”, filed on Oct. 21, 1995, and in JP 09-110285 entitled “Bookbinding Device and Image Forming Device”, published on Apr. 28, 1997, and is practiced by the Standard Accubind Pro bookbinder and the MEM AutoBook Bookletmaker sold by Whitaker Brothers, Rockville, Md., USA. It will be appreciated that such approaches require the use of additional consumables to bind the pages and further that in many cases it is necessary to provide several different types of consumables to achieve binding that has a desirable aesthetic appearance. For example, where a single size of adhesive tape is used as binding material, the adhesive tape will have a width that is sized to extend across a stack thickness of a maximum number of prints in the stack. However, where such a single tape is used to bind only a few prints together, excess adhesive material is provided and this excess adhesive material can for example, negatively impact the appearance of the bound product. Alternatively, to the extent that an electrophotographic printing system requires the use of multiple different sizes of binding tape can be used but this in turn creates supply, loading and other logistical problems.

In the area of electrophotographic printing, it has long been proposed to use electrophotographic toner to bind two or more prints together. Typically, this involves applying toner to a page for the dedicated purpose of being used for page binding purposes. The dedicated toner is then fused for a first time to the page. The page with the toner fused to it is stacked with another page or folded onto itself. Pressure and heat are applied across page where the dedicated toner is fused to cause the dedicated toner to fuse for a second time to bind the pages. Examples of this include, U.S. Pat. No. 3,793,016, entitled “Electrophotographic Sheet Binding Process” issued Feb. 19, 1974, which describes the formation of a high density area of toner on a set of sheets and re-fusing the toner between adjacent overlaying sheets to provide bound stacks without requiring additional binding material. Further examples of this approach can be found in U.S. Pat. No. 3,794,550 entitled: “Sheet Binding”, issued Feb. 26, 1974, U.S. Pat. No. 5,014,092 entitled: “Image Forming Apparatus with a Binding Function” issued May 7, 1991, U.S. Pat. No. 4,343,673, entitled: “Binding Apparatus and Method” issued Aug. 10, 1982, U.S. Pat. No. 5,582,570, entitled: “Method and Apparatus for Binding Sheets Using a Printing Substance” issued Dec. 10, 1996, U.S. Pat. No. 6,485,606 entitled: “Apparatus for Binding Sheet Media” issued Nov. 26, 2002, Japanese Publication No. 1995-0267511, published on Apr. 28, 1997, and in JP Publication No. 61-274764.

In such systems, all of the heat used for binding is conveyed into the pages of stack through a top page and a bottom page of the stack. The heat applied at these points must penetrate through the entire thickness of the stack with enough intensity to fuse toner in the middle of the stack. Accordingly, where there are many pages in the stack the amount of heat that must be applied to the top page and to the bottom page to fuse all of the toner provided for binding purposes in such a manner is significant. Further, such heat must be applied over a meaningful amount of time so as to prevent overheating of the top page and bottom page of the stack while still delivering the requisite thermal energy. Both the amount of heat required and the amount of time required increase with the number of pages in the stack.

Importantly, it is to be understood that the heat that is introduced into a stack in this manner does not propagate only through the portion of the pages in the stack having toner that is applied for binding. Instead such heat propagates along the length of the pages as well. This has the effect of heating portions of the pages that are that are not used for binding. Given the amount of heat that must be applied to a stack and the amount of time required to fuse all of the dedicated toner in a stack, the propagation of heat along the pages can cause toner other than the dedicated toner to fuse causing unwanted binding and image damage to images printed on the pages.

Accordingly, other approaches have been proposed for binding stacks of prints using thermally fusable toner as an adhesive. For example, in the '550 patent and the '016 patent it is proposed that a heated dual platen system have “additional heating means provided in a bottom surface against which a stack abuts” and that chemical, pressure or other fusing techniques be used. While additional heat will increase the probability of good binding, such additional heat can increase the total amount of heat applied to the stack and can increase the risk that toner that is fused to a page for a purpose other than binding will be fused in addition to the dedicated toner used for binding.

Alternatively, U.S. Pat. No. 5,582,570, entitled “Method and Apparatus for Binding Sheets using a Printing Substance”, issued Dec. 10, 1996, describes a method and apparatus for binding sheets using a reactivatable printing substance such as toner. The apparatus comprises a printing device for applying printing toner to a binding edge of a sheet. Printing text can be applied simultaneously to the sheet by the printing device. The sheet is transferred through a preheat station to an overlay location where additional sheets having strips of toner adjacent to a binder edge thereof are overlaid, one at a time. As each sheet is overlaid, the toner strip on the preceding sheet is fused to the uppermost sheet. Such fusing can be accomplished using a heated platen or wheel that bears upon the uppermost sheet.

This one page-at-a time approach to fusing limits the amount of heat that must be passed through any individual sheet in a stack but can have the effect of reducing output speeds.

Further, it is not clear that the problem of unwanted heating of image forming toner during a second fusing is resolved by fusing one page at a time. For example, the '764 publication discloses a system that is used in cementing products of paper, sheets, etc. especially inscription sheets e.g. single sheet letters. In this system an adhesive is applied at predetermined fixed adhesive points of the product intended for copying printing, etc., then fixed and again activated and thus converted into an adhesive state. The points of the product to be adhered can be cemented together. The adhesive points are produced by means of electrostatic charge. Similarly, the above-referenced '051 publication is directed to solving the problem of easily and costlessly making envelopes without applying an expensive adhesive. In this publication, a toner image for sticking is formed on a part of the peripheral edge and the folding part of a paper. After the paper, has been folded in two, with the toner image at the inside, the part of the toner image is pressed with heat to melt the toner and bind the paper. In this way, the peripheral edge of an envelope is sealed. However, U.S. Pat. No. 7,260,354, entitled “Image Forming Method” issued on Aug. 21, 2007, notes that the heat and pressure applied to cause the toner used for binding in the '764 and '051 publications to fuse for the second time causes the toner for the image portion to fuse resulting in adhesion throughout the toner image. As a result, the toner image is said to deteriorate.

As an alternative, the '345 patent, and JP Publication 2004-126,229, propose the use of special toners that are formulated to include an adhesive that can bind pages together without heating the pages to temperatures that will cause the toner used for image forming to fuse. Specifically, the '345 patent proposes the use of a special toner that fuses at a temperature that is lower than a temperature of the toner used for image formation, while the '229 publication discloses the use of a toner having a pressure sensitive adhesive that can be deposited as a toner and made adhesive by application of pressure in a subsequent binding process. Similarly, U.S. Pat. No. 5,521,429 discloses using toners having and ultraviolet light activated adhesives.

It has also been proposed to apply energy to a stack that will cause the toner in the stack to heat from within. For example, the '429 patent also discloses applying vibration and pressure to generate heat in the fusing heat in the stacks, while U.S. Pat. No. 6,294,728, entitled “Binding Sheet Media Using Imaging Material” issued on May 28, 2002 describes a system that uses two bars to apply pressure and heat for fusing toner bearing sheets but notes that for large stacks of paper it may be necessary to heat through the stack and that additionally a variety of techniques can be used for this purpose including, ultrasound magnetic energy radio frequency energy and other forms of electromagnetic energy.

In summary, despite many decades of development, what is still needed in the art is a method that allows electrophotographic prints to be thermally bound together using a conventional toner while protecting images formed on the prints.

### SUMMARY OF THE INVENTION

Methods and printers are provided for forming bound electrophotographic prints are provided. In one aspect, the method comprises the steps of applying a toner to a receiver to form a toner image with having toner in a binding area and in an image area. The binding area is proximate to a binding edge of the receiver and the image area that is separated from the binding area by an separation area; (printers). The toner image is fused to form a print, and a sheet and the prints are stacked with the toner in the binding area of the print confronting the sheet along a binding edge of the sheet. Heat is applied at the binding edges to cause the toner in the binding area to fuse for a second time. A residual portion of the applied heat heats the separation area but the separation area does not heat the image area to an extent sufficient to fuse toner in the image area.

### BRIEF DESCRIPTION OF THE DRAWINGS

FIG. 1 is a system level illustration of one embodiment of an electrophotographic printer;

FIG. 2 shows one embodiment of a binding system;

FIG. 3 shows the embodiment of FIG. 2 with a pressure system activated;

FIG. 4 shows a flow diagram of the embodiment of FIG. 2 with electrophotographic print binding method.

FIG. 5 shows the embodiment of FIG. 2 with an alignment surface in a second position.

FIG. 6 shows the embodiment of FIG. 2 with fused toner in the binding area engaging binding edges of a stack of sheets;

FIG. 7 shows another embodiment of a positioning system useful in a binding system.

FIG. 8 shows the embodiment of FIG. 7 with a stack of sheets moved into contact with fused toner;

FIG. 9 illustrates another embodiment or a positioning system useful in a binding system.

FIG. 10 illustrates the embodiment of FIG. 9 with a stack moved into contact with fused toner;

FIG. 11 illustrates sheets having separation area between a contact area that contacts the fused toner and toner arranged to form an image on the sheet.

### DETAILED DESCRIPTION OF THE INVENTION

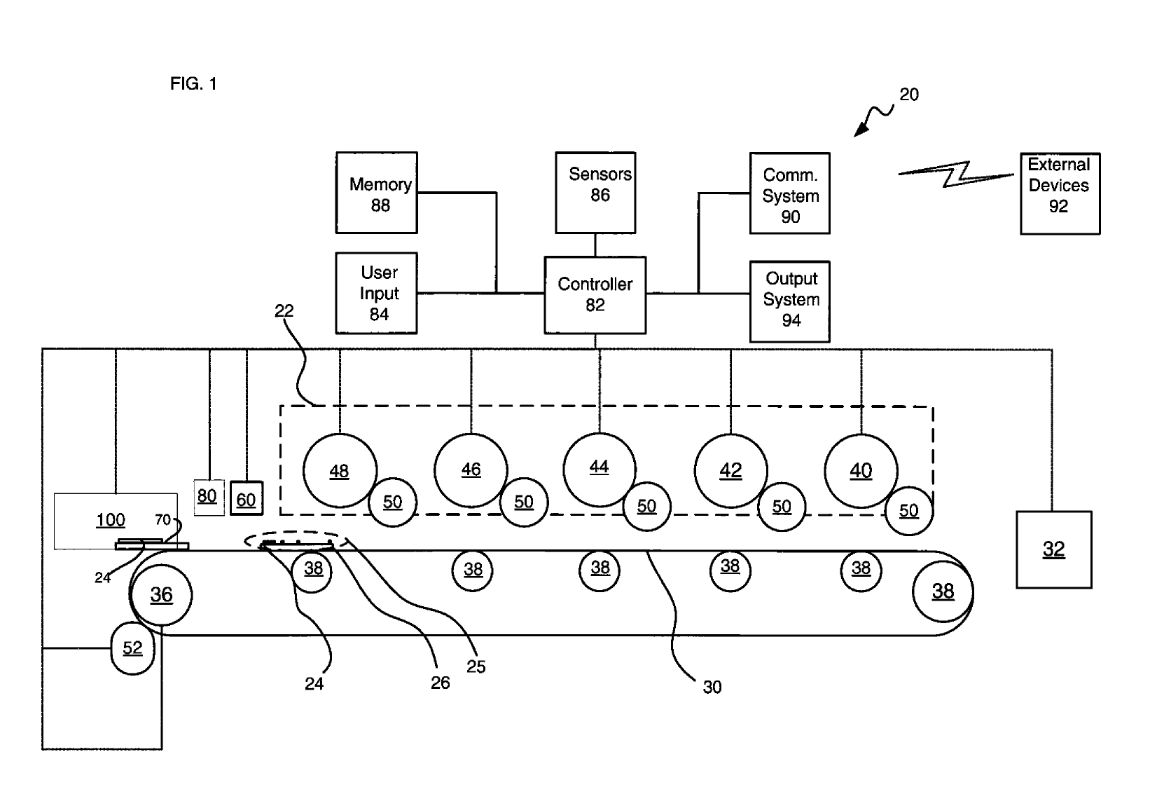

FIG. 1 is a system level illustration of an electrophotographic printer 20. In the embodiment of FIG. 1, electrophotographic printer 20 has an electrophotographic print engine 22 that deposits toner 24 to form a toner image 25 in the form of a patterned arrangement of toner stacks. Toner image 25 can include any patternwise application of toner 24 and can be mapped according data representing text, graphics, photo, and other types of visual content, as well as patterns that are determined based upon desirable structural or functional arrangements of the applied toner 24.

Toner 24 is a material or mixture that contains toner particles, and that can form an image, pattern, or coating when electrostatically deposited on an imaging member including a photoreceptor, photoconductor, electrostatically-charged, or magnetic surface. As used herein, “toner particles” are the marking particles used in an electrophotographic print engine 22 to convert an electrostatic latent image into a visible image. Toner particles can also include clear particles that can provide for example a protective layer on an image or that impart a tactile feel to the printed image.

Toner particles can have a range of diameters, e.g. less than 8 μm, on the order of 10-15 μm, up to approximately 30 μm, or larger. When referring to particles of toner 24, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner 24 is also referred to in the art as marking particles or dry ink.

Typically, receiver 26 takes the form of paper, film, fabric, metallicized or metallic sheets or webs. However, receiver 26 can take any number of forms and can comprise, in general, any article or structure that can be moved relative to print engine 22 and processed as described herein.

Returning again to FIG. 1, print engine 22 can be used to deposit one or more applications of toner 24 to form toner image 25 on receiver 26. A toner image 25 formed from a single application of toner 24 can, for example, provide a monochrome image.

A toner image 25 formed from more than one application of toner 24, (also known as a multi-part image) can be used for a variety of purposes, the most common of which is to provide toner images 25 with more than one color. For example, in a four toner image, four toners having subtractive primary colors, cyan, magenta, yellow, and black, can be combined to form a representative spectrum of colors. Similarly, in a five toner image various combinations of any of five differently colored toners can be combined to form other colors on receiver 26 at various locations on receiver 26. That is, any of the five colors of toner 24 can be combined with toner 24 of one or more of the other colors at a particular location on receiver 26 to form a color different than the colors of the toners 24 applied at that location.

In the embodiment that is illustrated, a primary imaging member (not shown) such as a photoreceptor is initially charged. An electrostatic latent image is formed by image-wise exposing the primary imaging member using known methods such as optical exposure, an LED array, or a laser scanner. The electrostatic latent image is developed into a visible image by bringing the primary imaging member into close proximity to a development station that contains toner 24. The toner image 25 on the primary imaging member is then transferred to receiver 26, generally by pressing receiver 26 against the primary imaging member while subjecting the toner to an electrostatic field that urges the toner to receiver 26. The toner image 25 is then fixed to receiver 26 by fusing to become a print 70.

In FIG. 1 print engine 22 is illustrated as having an optional arrangement of five printing modules 40, 42, 44, 46, and 48, also known as electrophotographic imaging subsystems arranged along a length of receiver transport 28. Each printing module delivers a single application of toner 24 to a respective transfer subsystem 50 in accordance with a desired pattern as receiver 26 is moved by receiver transport 28. Receiver transport 28 comprises a movable surface 30, positions that moves receiver 26 relative to printing modules 40, 42, 44, 46, and 48. Surface 30 comprises an endless belt that is moved by motor 36, that is supported by rollers 38, and that is cleaned by a cleaning mechanism 52.

Also shown in FIG. 1 is an optional folding system 80. Folding system 80 can take the form of any type of folding system that can be used to fold prints 70 as described herein.

Referring again to FIG. 1, electrophotographic printer 20 is operated by a controller 82 that controls the operation of print engine 22 including but not limited to each of the respective printing modules 40, 42, 44, 46, and 48, receiver transport 28, receiver supply 32, transfer subsystem 50, to form a toner image 25 on receiver 26 and to cause fuser 60 to fuse toner images 25 on receiver 26 to form prints 70 as described herein.

Controller 82 operates electrophotographic printer 20 based upon input signals from a user input system 84, sensors 86, a memory 88 and a communication system 90. User input system 84 can comprise any form of transducer or other device capable of receiving an input from a user and converting this input into a form that can be used by controller 82. For example, user input system 84 can comprise a touch screen input, a touch pad input, a 4-way switch, a 6-way switch, an 8-way switch, a stylus system, a trackball system, a joystick system, a voice recognition system, a gesture recognition system or other such systems. Sensors 86 can include contact, proximity, magnetic, or optical sensors and other sensors known in the art that can be used to detect conditions in electrophotographic printer 20 or in the environment-surrounding electrophotographic printer 20 and to convert this information into a form that can be used by controller 82 in governing printing and fusing. Memory 88 can comprise any form of conventionally known memory devices including but not limited to optical, magnetic or other movable media as well as semiconductor or other forms of electronic memory. Memory 88 can be fixed within electrophotographic printer 20, removable from electrophotographic printer 20 at a port, memory card slot or other known means for temporarily connecting a memory 88 to an electronic device. Memory 88 can also be connected to electrophotographic printer 20 by way of a fixed data path or by way of communication system 90.

Communication system 90 can comprise any form of circuit, system or transducer that can be used to send or receive signals to memory 88 or external devices 92 that are separate from or separable from direct connection with controller 82. Communication system 90 can connect to external devices 92 by way of a wired or wireless connection. In certain embodiments, communication system 90 can comprise a circuitry that can communicate with such separate or separable device using a wired local area network or point to point connection such as an Ethernet connection. In certain embodiments, communication system 90 can alternatively or in combination provide wireless communication circuits for communication with separate or separable devices using a Wi-Fi or any other known wireless communication systems. Such systems can be networked or point to point communication.

External devices 92 can comprise any type of electronic system that can generate wireless signals bearing data that may be useful to controller 82 in operating electrophotographic printer 20. For example and without limitation, an external device 92 can comprise what is known in the art as a digital front end (DFE), which is a computing device that can be used to provide images and or printing instructions to electrophotographic printer 20.

An output system 94, such as a display, is optionally provided and can be used by controller 82 to provide human perceptible signals for feedback, informational or other purposes. Such signals can take the form of visual, audio, tactile or other forms.

As is shown in FIG. 1, electrophotographic printer 20 further comprises a binding system 100. In FIG. 1, binding system 100 is integral to electrophotographic printer 20. In other embodiments, binding system 100 can be modularly joinable to electrophotographic printer 20. In still other embodiments, binding system 100 can be a stand-alone device that cooperates with electrophotographic printer 20.

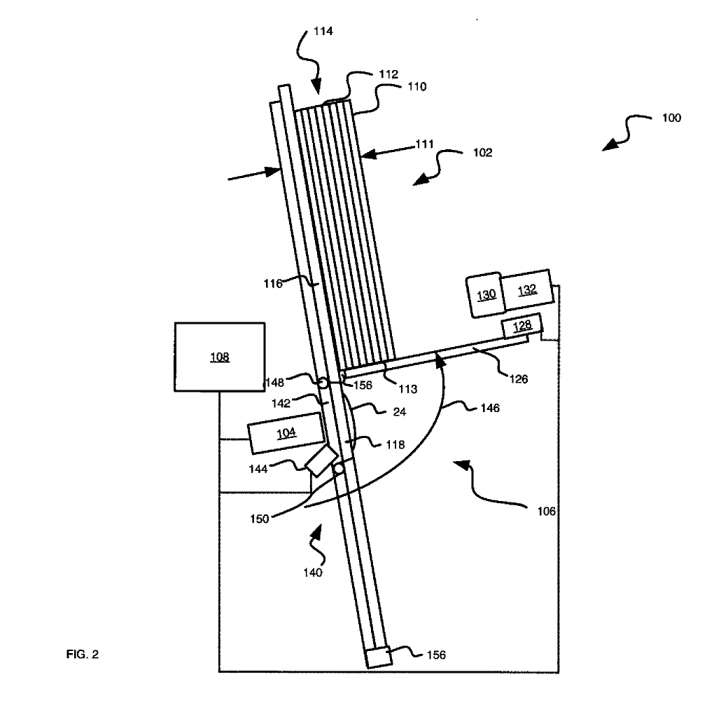

FIG. 2 shows a first embodiment of a binding system 100. In this embodiment, binding system 100 comprises a stacking system 102, a heater 104, positioning system 106 and a binding system controller 108.

Generally stacking system 102 can take the form of any system that can be used to form a stack 110 of sheets 112 in a stacking area 114 that is bounded in part by a stack support wall 122 and an alignment surface 126. As will be described in greater detail below, a sheet 112 can have toner arranged to form an image (not shown) or it can comprise an unprinted receiver 26. Sheet 112 can also comprise any other material that can be stacked and bound to an outer print 116 using toner 24.

Heater 104 has at least one heat source which can take the form of any known source of heat that can be applied to heat toner 24 to an extent necessary to cause toner 24 to fuse. In embodiment of FIG. 2, heater 104 is an electrical heater which can take the form of an electrical contact, convection, or radiant heat source including, but not limited to, resistive heated plates, tapes or surfaces, heated air, as flash, quartz, laser, or other optical heaters, resistive tapes and the like.

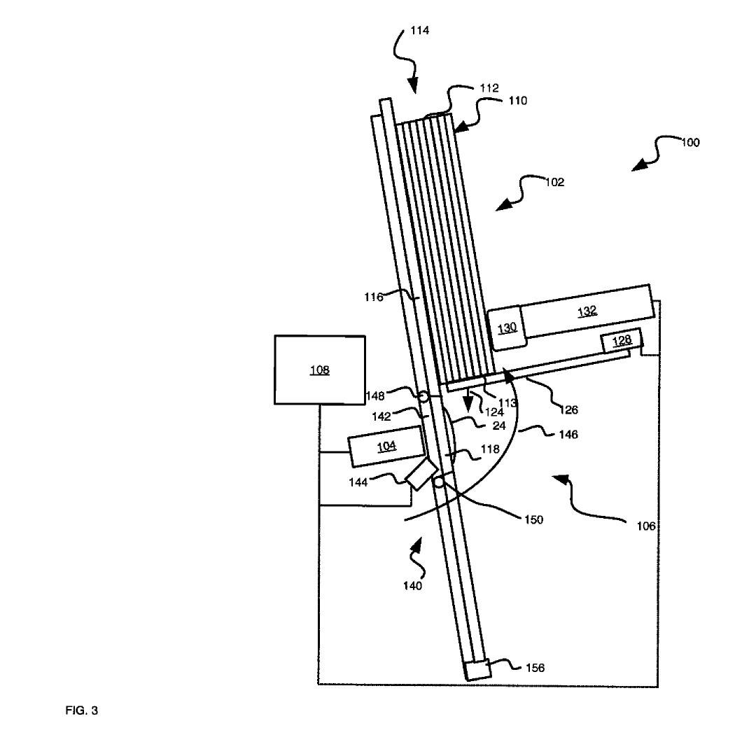

In the embodiment of FIG. 2, positioning system 106 has a stack positioning system 120, and an outer print positioning system 140. Stack positioning system 120 has a stack support wall 122 which can comprise any surface or combination of surfaces along which stack 110 can be placed, an alignment surface 126 and an alignment surface actuator 128. Alignment surface 126 is movable between a first position as illustrated in FIG. 2, wherein alignment surface 126 is used to align sheets 112 in stacking area 114 while the stacking is occurring and a second position shown in FIG. 3 where alignment surface 126 has been moved by alignment surface actuator 128 to a position where it no longer aligns sheets 112 in stacking area 114. As is shown in this embodiment, stacking area 114 is aligned on a vertical slope and alignment surface 126 is used to support sheets 112 against the pull of gravity 124 as sheets 112 are deposited in stacking area 114 by stacking system 102.

Stack positioning system 120 also has a pressure surface 130 with an actuator 132 positioned to move from the position illustrated in FIG. 2 to the position illustrated in FIG. 3 to drive pressure surface 130 across stacking area 114 with sufficient force to hold stack 112 from movement when a force is applied to stack 110. With a vertically arranged stack as shown, this force can comprise gravity 124 or other forces applied for example, to stack 110.

Positioning system 106 also provides an outer print positioning system 140 that has an outer print support surface 142 that is moved by an outer print actuator 144. In the embodiment illustrated in FIG. 2, outer print actuator 144 is moved along a radial path 146 around a first pivot 148.

As shown here, outer print support surface 142 is positioned proximate to heater 104 so that a binding portion area 118 of an outer print 116 resting on outer print support surface 142 can be heated to cause toner 24 in binding area 118 to fuse.

Binding system controller 108 controls operation of a stacking system 102, heater 104, and positioning system 106 and can comprise any known type of electronic or electrical control system. In certain embodiments the functions described being here as performed by binding system controller 108 can be performed by printer controller 82. Binding control system 108 cooperates with printer controller 82 as necessary to determine what stacking and binding operating are to be performed and optionally how those operations are to be performed.

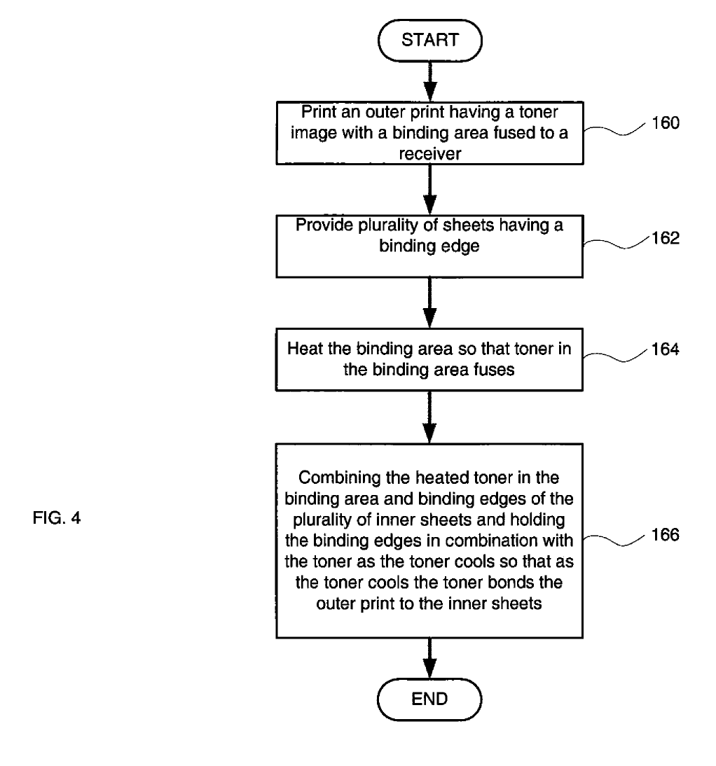

A flow diagram of one embodiment of an electrophotographic print binding method using a printer 20 having binding system 100 is shown in FIG. 4. In accordance with this embodiment, when printer controller 82 receives print order information calling for production of a bound stack 110 of sheets 112, or receives instructions from user input system 94 requesting a bound stack of sheets 112, printer controller 82 causes an outer print 116 to be printed having a toner image 25 with toner 24 fused to a receiver 26 in a binding area 118 (step 160). As shown in FIG. 2, after outer print 116 is printed toner 24, outer print 116 is provided to stacking system 102 and is stored in stacking area 114 against stack support wall 122, outer print support surface 142, a fold surface 152 and an edge 154.

Characteristics of binding area 118 such as a size or shape of binding area 118 the amount of toner 24 to be applied in binding area 118 and a pattern of toner 24 applied in binding area 118 are determined by printer controller 82. Printer controller 82 can use any of a variety of factors in determining the characteristics of binding area 118. In one example, the characteristics of binding area 118 are determined externally and provided in the print order information provided to printer controller 82. In the example printer controller 82 uses the instructions provided in the print order information to define the characteristics of binding area 118. In another example, the print order information can include data from which printer controller 82 can determine such a characteristic of binding area 118. Such data can include, for example, data that defines stack height 111 and/or an estimate of stack height 111 of stack 110 that controller 82 uses to determine at least one characteristic of binding area 118.

Alternatively, controller 82 can determine a characteristic of binding area 118 by analyzing printer order information, for example, by estimating a stack height 111 that stack 110 will have when printed and stacked. In one embodiment, such an estimate is made based upon the number of sheets 112 to be used to form stack 110. In another embodiment, such an estimate can be made based upon a number of sheets 112 in a stack 110 the thickness of sheets 112 in stack 110 and the thickness of any toner 24 applied to each. Such a determination can be made by calculation according to a sheet thickness calculation that considers such factors, or by reference to a look up table, or the use of so called fuzzy logic. For example and without limitation, a length of one dimension of the binding area 118 can be determined based upon such an estimate of stack height 111. Similarly, other characteristics of binding area 118 or toner 24 laid down in binding area 118 can be determined based upon the estimated stack height 111, including but not limited to the pattern of toner 24 applied in binding area 118 and the thickness of toner 24 applied in binding area 118.

A plurality of sheets 112 is provided each having a binding edge 113 (step 162). In the embodiment illustrated, sheets 112 are provided by receiver transport 28 to binding system 100 and stored in stacking area 114. As shown in FIG. 2, sheets 112 are supported by alignment surface 126 which bisects stacking area 114 while outer print 116 passes through a gap 156 between alignment surface 126 and stack support wall 122 to be supported by a an edge 154. As is also shown in FIG. 2, outer print 116 and alignment surface 126 are proximate to each other with alignment surface 126 positioning stack 110 so that binding edges 113 of prints 112 are aligned generally proximate to a top portion of binding area 118 and pivot 148.

Binding area 118 of outer print 116 is then heated so that toner 24 in binding area 118 fuses (step 164). In the embodiment of FIG. 2, heater 104 is shown located alongside outer print supports surface 142 adjacent to binding area 118. Binding system controller 108 causes heater 104 to emit heat against a side of outer print 116 that is opposite from the side on which toner 24 is formed in binding area 118. Controller 108 causes heater 104 to emit heat until toner 24 in binding area 118 on outer print 116 is fused.

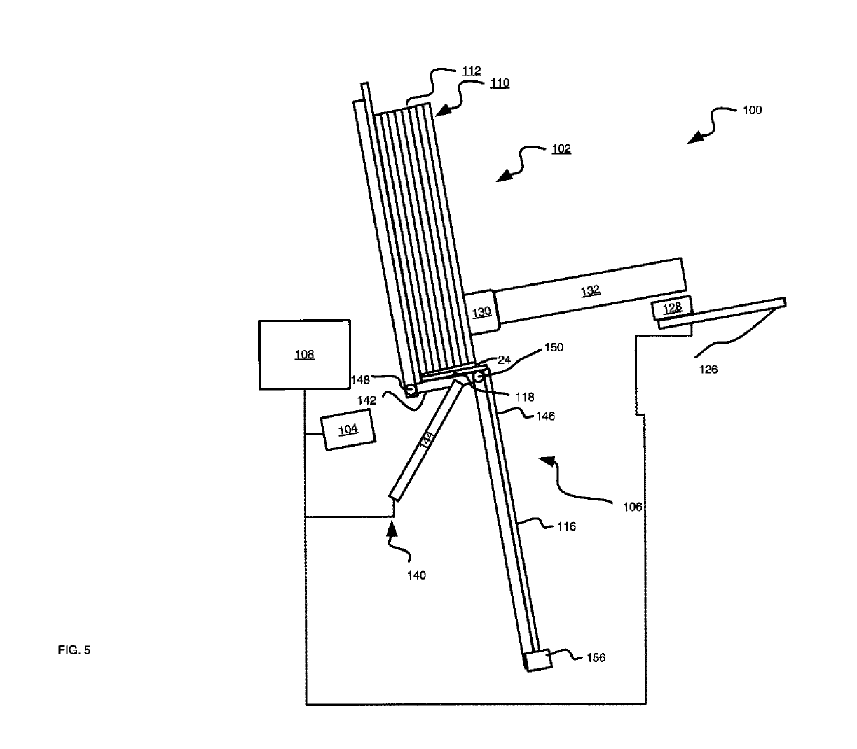

Fused toner 24 in binding area 118 is then combined with binding edges 113 of sheets 112 in stack 110 and held in combination as the toner cools so that toner 24 bonds outer print 116 to sheets 112 (step 166). In the embodiment of FIGS. 2 and 3, binding system controller 108 causes this to occur by sending signals pressure surface actuator causing pressure surface actuator 132 to drive pressure surface 130 against stack 110 so that stack 110 is pushed against the portion of outer print 116 that is above alignment surface 126 in stacking area 114 and with sufficient force as to hold stack 110 together and in position relative to outer print 116 against the pull of gravity 124 as shown in FIG. 3. Binding system controller 108 then causes alignment surface actuator 128 to move to a second position as shown in FIG. 5, where alignment surface 126 is not between binding area 118 and binding edges 113.

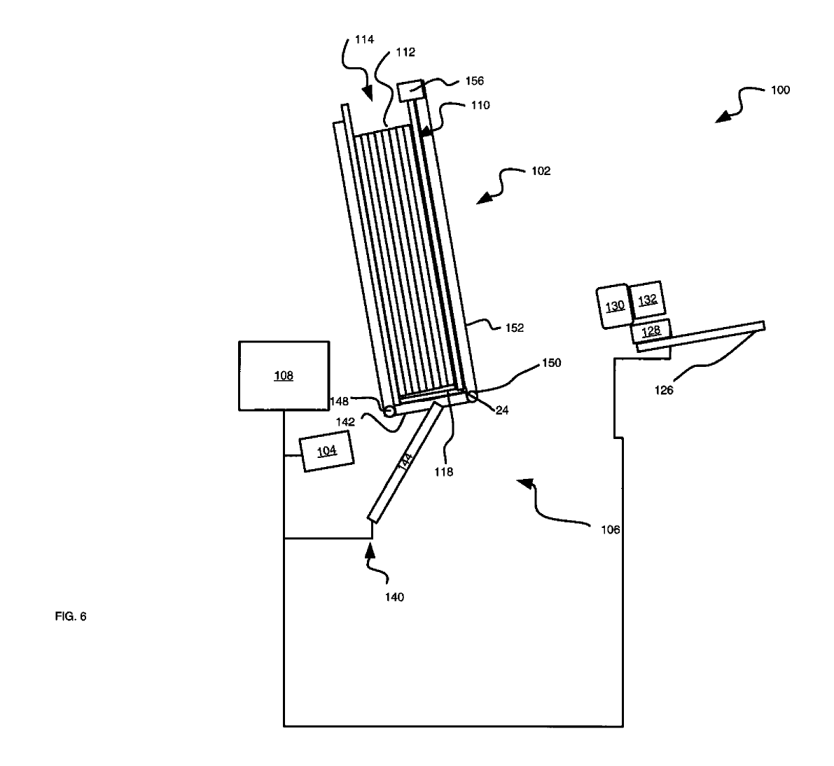

Binding system controller 108 then sends signals to outer print actuator 144 causing outer print actuator 144 to advance outer print support surface 142 along radial path 146 to move binding area 118 proximate to binding edges 113 so that fused toner 24 in binding area 118 can engage edges 113, as shown in FIG. 6. Because toner 24 in binding area 118 is fused it is compliant and will adapt to binding edges 113 when edges 113 and fused toner 24 in binding area 118 are brought into engagement and held in engagement as toner 24 cools. As toner 24 in binding area 118 cools, a bond is formed between sheets 112 and outer print 116.

Also shown in the embodiment of FIG. 2, is a support sensor 149 that is positioned to detect when outer print actuator 144 has moved outer print support surface 142 so that binding area 118 of outer print 116 are moved to a position that enables binding of toner 24 to binding edges of sheets 112. In the embodiment that is illustrated, support sensor 149 is shown as a sensor that detects a change in position of outer print support surface 142 or outer print actuator 144 that indicates that support wall 122 has been properly positioned so that toner 24 can engage the binding edges 113. Alternatively, support sensor 149 can comprise a pressure sensor that senses an amount of pressure that outer print actuator 144 applies to drive outer print support surface 142 and outer print 116 along radial path 146. Such a pressure sensor embodiment of stack support sensor 149 can detect when the amount of pressure required to move outer print support surface and outer print 116 reaches a level that indicates that such movement is being resisted by engagement between fused toner 24 in binding area 118 and binding edges 113 of stack 112. This can be used by binding system as a signal to stop advancing stack 110 toward binding area 118 of outer print 116.

It will be appreciated that in this embodiment, sheets 112 are not heated as part of the process used to heat toner 24 in binding area 118 and that in this embodiment, sheets 112 do not contact toner 24 in binding area 118 until after toner 24 has been brought to a fused state. Accordingly, sheets 112 only engage toner 24 in binding area 118 as a part of the process of cooling the toner and, in that respect, toner 24 may convey some heat into sheets 112. The amount of heat so conveyed is substantially less than the amount of heat conveyed during types of fusing wherein sheets themselves are heated to a fusing temperature or above so that such sheets can conduct heat to toner in order to fuse the toner. Further, because sheets 112 will absorb heat from toner 24, toner 24 that contacts and bonds to a sheet in sheet 112 will be among the first portion of toner 24 to cool from the fused state to a solid state. The solidified portion of toner 24 bonds to sheets 112 and provides additional thermal insulation between sheet 112 and any unfused toner 24 that can reduce either or both of the amount of heat transmitted by toner 24 into an individual sheet 112 or the rate at which such heat enters into sheets 112. Accordingly, substantially less heat will be transferred into prints 112 to fuse toner 24 that sheets 112 have toner 24 that is arranged to form images and that is fused to sheets 112, such heat will not be sufficient to cause such toner to fuse.

As is shown in FIG. 6, after toner 24 cools, binding system controller 108 causes pressure surface actuator 132 to retract pressure surface 130 from stack 100, and to fold actuator (not shown) to wrap fold surface 152 around stack 112, so that outer print 116 wraps around stack 110.

It will also be appreciated that, in the embodiment shown in FIGS. 2, 3, 4, 5 and 6, the separation between binding edges 113 and the positioning of alignment surface 126 between binding edges 113 of sheets 112 and heater 104 during heating provides further thermal shielding of sheets 112 during the process of heating toner 24 in binding area 118.

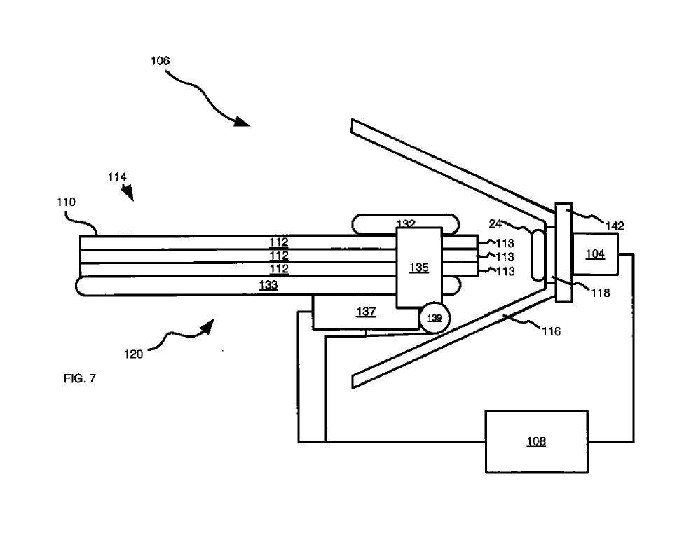

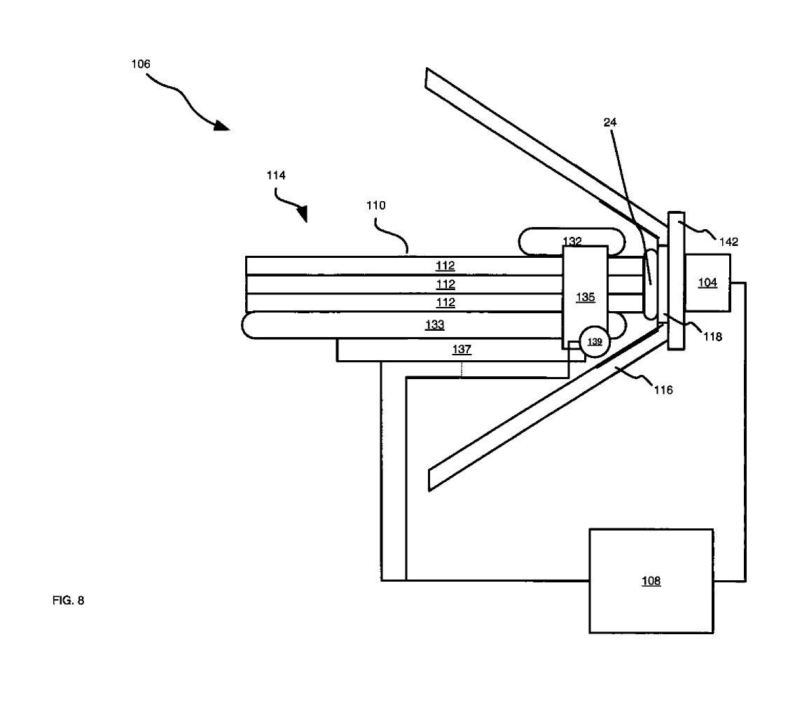

FIGS. 7 and 8 show another embodiment of positioning system 106. In this embodiment, positioning system 106 has a stack positioning system 120 with pressure surface 130 clamp stack by pressure surface actuator 132 as through stack 110 against an opposing pressure surface 133 to apply a pressure (P) to hold stack 110 of sheets 112 together and to allow stack 110 to move without disturbing the stacked arrangement of sheets 112. In this embodiment, pressure surface 130 and opposing pressure surface 133 are movable relative to an outer print support surface 142 that supports binding area 118 of outer print 116.

In this embodiment, the step of combining (step 166) is performed when binding system controller 108 which causes pressure surface actuator 132 to apply pressure (P) across stack 110 of sheets 112, and then cause stack advance actuator 137 to move pressure surface 130 and opposing pressure surface 133 to move stack 110 from a first position shown in FIG. 7 to a second position shown in FIG. 8 where binding edges 113 are moved into contact with toner 24 in a binding area 118 of an outer print 116. In the embodiment of FIGS. 7 and 8, toner 24 in binding area 118 is positioned by outer print support surface 142 proximate to stacking area 114 and is arranged along binding edges 113 of the sheets 112 of stack 110. In alternative embodiments, outer print support surface 142 can be positioned at any convenient location to which stack 110 can be moved by stack positioning system 120.

Binding system controller 108 causes heater 104 to heat binding area 118 while binding edges 113 are in the first position and separated from binding area 118. This allows toner 24 in binding area 118 to be heated and to fuse without directly applying any heat to sheets 112. Further, as shown in FIG. 8, heater 104 is optionally positioned on a side of outer print support surface 142 that is opposite from binding area 118 such that as heat is applied by heater 104 outer print 116 and any toner 24 in binding area 118 act to shield sheets 112 from the applied heat.

Once that toner 24 in binding area 118 is heated sufficiently to fuse toner 24, binding system controller 108 causes stack positioning system 120 to move stack 110 from the first position separated from binding area 118 into the second position illustrated in FIG. 8 where stack 110 is moved into contact with toner 24 in binding area 118. Heater 104 can be turned off at or before such contact is made so long as toner 24 is still fused when contact is made. Also shown in the embodiment of FIGS. 7 and 8 is a stack advance sensor 139 that is positioned to detect when binding edges 113 of sheets 112 in stack 110 have been moved into a position where they engage toner 24 to an extent that is sufficient to allow binding edges 113 to bind toner 24 in binding area 118 of outer sheet 116. In the embodiment that is illustrated, stack advance sensor 139 is shown as a positional sensor that detects a change in position of stack 110 or the stack positioning system 120 that would indicate that stack 110 has been properly positioned for binding. Alternatively, stack advance sensor 139 can comprise a pressure sensor that senses an amount of pressure that stack advance applies to drive sheets 112 into toner 24. Such a pressure sensing embodiment of stack advance sensor 139 detects the amount of pressure required to move stack 110 and generates a signal based upon such sensed pressure from which binding system controller 108 can determine when the pressure reaches a level that indicates that such movement is being resisted by fused toner 24 in binding area 118. When such pressure is detected binding system controller 108 can stop stack advance actuator 137 from advancing stack 110 toward binding area 118 of outer print 116 and/or can cease the application of heat to binding area 118.

As in the embodiment that is illustrated in FIGS. 2, 3, 4, 5 and 6, it will be appreciated that sheets 112 are not heated as part of the process used to heat toner 24 in binding area 118 and in this embodiment, do not contact toner 24 until the toner 24 in binding area 118 has been brought to a fused state. Accordingly, sheets 112 only engage toner 24 in binding area 118 as a part of the process of cooling the toner 24 in binding area 118 and, in that respect, toner 24 may convey some heat into sheets 112. The amount of heat so conveyed is substantially less than the amount of heat conveyed during a type of fusing wherein the sheets themselves are heated and must conduct heat to the toner in order to fuse the sheets. Further, because sheets 112 will absorb heat from toner 24, portion of toner 24 that contacts sheets 112 will be among the first portions of toner 24 in binding area 118 to cool from the fused state to a solid state. This first cooled portion toner 24 will bond to the sheets and provide additional thermal insulation that can reduce either or both of the amount of heat transmitted by toner 24 into an individual sheet 112 or the rate at which such heat enters into sheets 112. Accordingly, in this embodiment as well substantially less heat will be transferred into prints 112 than in systems that require sheets 112 to heat toner 24 and, to the extent that sheets 112 have toner 24 that is arranged to form images and that is fused to sheets 112, such heat will not be sufficient to cause toner 24 to fuse.

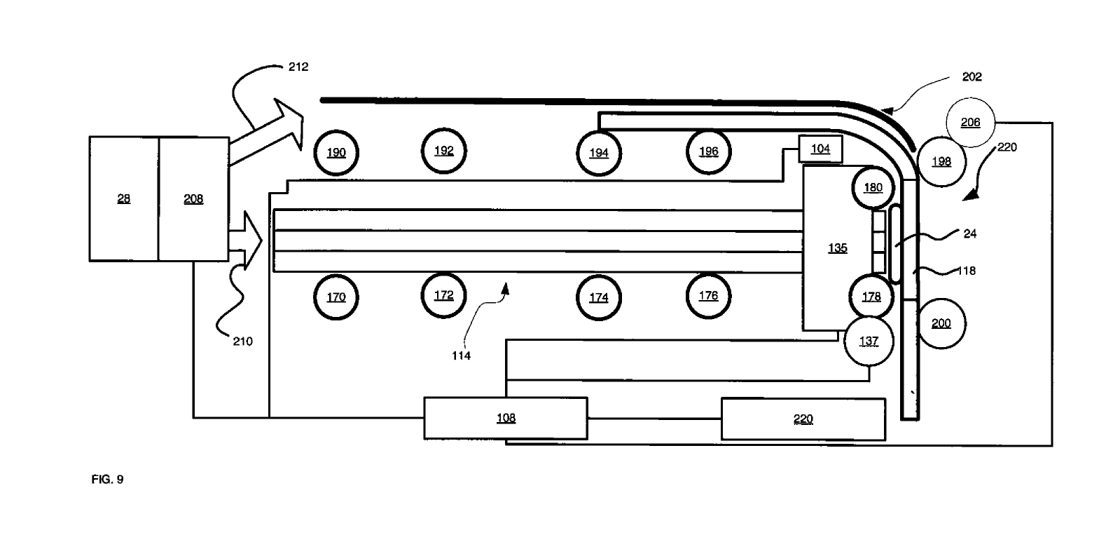

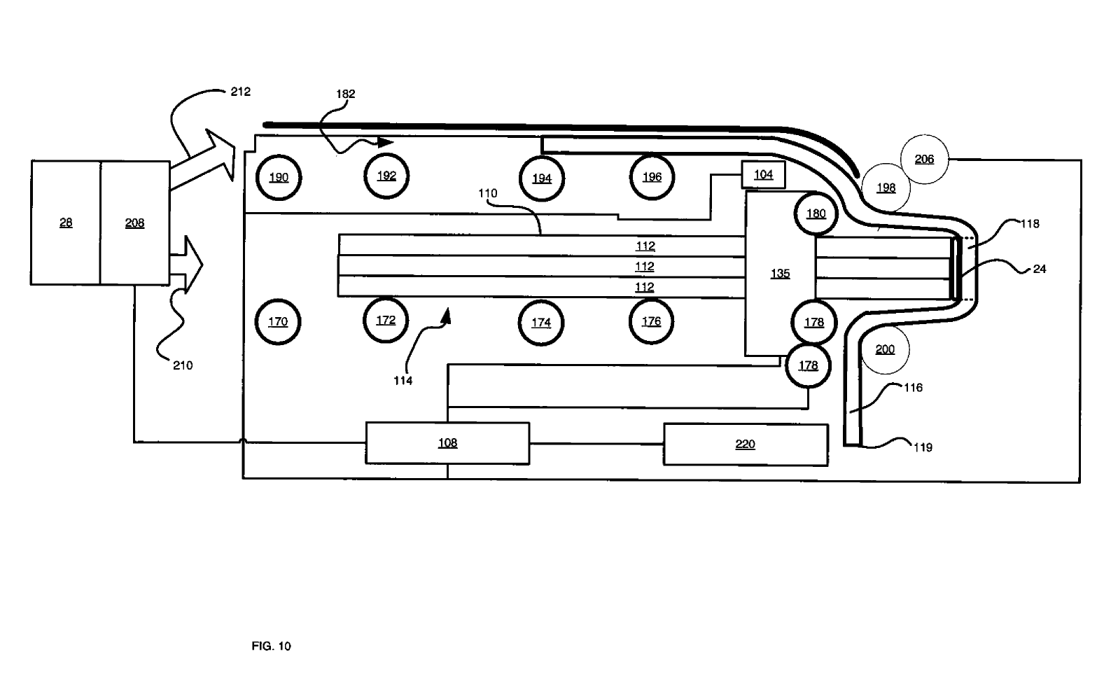

FIGS. 9 and 10 illustrate another embodiment of positioning system 106, where binding edges 113 of a stack 110 of prints 112 is moved to engage a fused toner 24 in binding area 118 of an outer print 116. In this embodiment, stacking area 114 forms stack 110 on a set of stack rollers 170, 172, 174, 176 and 178, with stack 110 being positioned between roller 178 and a pressure roller 180 proximate to binding edges 113. A pressure surface actuator 132 joins stack roller 178 and pressure roller 180 to apply a pressure across stack 110 to hold stack 110 when instructed to do so by binding system controller 108. Pressure P holds stack 110 proximate to binding edges 113.

Here, stack advance actuator 137 causes stack roller 178 to rotate in a clockwise direction to move stack 110 lengthwise between stack roller 178 and pressure roller 180 when instructed to do so by binding system controller 108. Alternatively, stack advance actuator 137 can rotate pressure roller 180 to move stack 110.

As is also shown in FIGS. 9 and 10, an outer print transport path 182 is provided adjacent to stacking area 114. In this embodiment outer print transport path 182 is shown as having outer print rollers 190, 192, 194 and 196, first guide roller 198, second guide roller 200, and guide surface 202. After an outer print 116 is formed having toner 24 in binding area 118, outer print 116 is into outer print transport path 182 instead of into stacking area 114. In this embodiment, such an outer print 116 is provided by receiver transport system 28 to diverter 208, which is provided between receiver transport system 28, stacking area 114 and outer print transport path 182. In this embodiment binding system controller 108, causes diverter 208 to direct sheets 112 along a first path 210 into stacking area 114 and directs an outer print 116 along a second path 212 into outer print transport path 182. Diverter 208, first path 210 and second path 212 can all be of any known configuration.

Once that outer print 116 enters outer print transport path 182, outer print 116 is guided between guide surface 202 and outer print rollers 190, 192, 194, 196. Any of outer print rollers 190, 192, 194, and 196 can be powered by a motor (not shown) to help advance outer print 112 through outer print transport path 182. Outer print transport path 182 carries outer print 116 along a path that parallels the arrangement of sheets 112 in stacking area 114 and that is curved to help guide outer print 116 across an engagement area 220 that is along a path that is normal to the arrangement of sheets 112 in stacking area 114. As is shown in FIG. 9, an outer print 116 is guided along outer print transport path is guided to guide roller 198 and second guide roller 200. First guide roller 198 and second guide roller is powered by motor 206 to help advance outer print 112 so that toner 24 in binding area 118 is positioned within the engagement area 220. Here a leading edge 119 of outer print 116 is sensed by a sensor 222 that detects when leading edge 119 passes or reaches sensor 222. Sensor 222 provides a signal to binding system controller 108 from which binding system controller 108 can determine when to instruct motor 206 to stop advancing outer print 116 in order to position binding area 118, in engagement area 220. As is shown, in this embodiment outer print 116 is positioned in outer print transport path 182 such that toner 24 in binding area 118 will confront the binding edges 113 of sheets 112 in stack 110 when binding area 118 is positioned at engagement area 220. Further as is shown in this embodiment, heater 104 is provided along outer print transport path. When actuated heater 104 heats toner 24 in binding area 118 to fuse toner 24. As shown here, this is done by causing heater 104 to apply heat to outer print 116 as binding area 118 passes heater 104 on the way to engagement area 220. As shown here, heater 104 applies heat to a side of outer print 116 having toner 24 applied thereto in binding area 118. The amount of heat will be calculated to heat toner 24 in binding area 118 so that toner 24 remains fused until the binding edges 113 of sheets 112 are brought into contact with toner 24.

As shown in FIG. 10, when outer print 116 is positioned with binding area 118 in engagement area, 220, binding system controller 108 causes pressure surface actuator 132 to cause stack roller 178 and pressure roller 180 to apply a pressure P across stack 110 to hold stack 110. Then binding system controller 108 causes stack advance actuator 137 to cause stack roller 178 and/or pressure roller 180 to rotate to move stack 110 through engagement area 220. This drives binding edges 113 of sheets 112 in stack 110 into binding area 118 and through first guide rollers 198 and second guide roller 200. As illustrated, this wraps outer print 116 around stack 110 to form a bound cover.

Optionally, the above described embodiments; the combining step (step 166) is described as occurring after toner 24 in binding area 118 has fused. However, in any of the above described embodiments, contact between binding system controller 108 can cause the binding edges 113 of sheets 112 to be applied against toner 24 in binding area 114 with a first pressure, before toner 24 in binding area 118 is fused. The first pressure is set to be sufficient to advance binding edges 113 of sheets 112 against toner 24 with a pressure that will cause binding edges 113 of sheets 112 to engage toner 24 in binding area 118 when toner 24 in binding area 118 is fused. However, when toner 24 in binding area 118 is in an unfused state, toner 24 will prevent movement of binding edges 113 to a position where the binding edges 113 of sheets 112 and toner 24 are positioned so that toner 24 can bond sheets 112 to outer print 116. In such an embodiment, movement of binding edges 113 to the second position that can be sensed for example by stack advance sensor 139 as discussed above and as discussed above stack advance sensor 139 can provide a signal to binding system controller 108. Binding system controller 108 can use this signal for example to determine when to discontinue the application of heat to binding area 118 or to determine when to cease applying a force to advance stack fused 112 toward 24 in binding area 118. Alternatively, stack advance sensor 139 can detect pressure applied by stack advance actuator 135 and can send signals to binding system controller 108 that can allow binding system controller 108 to determine that toner 24 in binding area 118 has fused. In still another embodiment of this type, stack advance sensor 139 can sense a condition from which binding system controller 108 can determine that stack 110 has been moved to from the first position toward the second and wherein binding system controller 108 can discontinues heating of toner 24 in binding area 118 based upon the detected movement of stack 110 from the first position toward the second position.

It will be appreciated that in these alternative embodiments, any toner 24 recorded on sheets 112 will be protected from unintended fusing by heating toner 24 in binding area 114 from a side of outer print 116 that is opposite from the side in which toner 24 is positioned binding edges 113 of sheets 112 are positioned. Accordingly, the last portions toner 24 that are heated during the fusing process are the portions of toner 24 that confront binding edges 113. Further, sheets 112 are protected from direct application heat applied by heater 104 by outer print 116 and toner 24 on outer print 116.

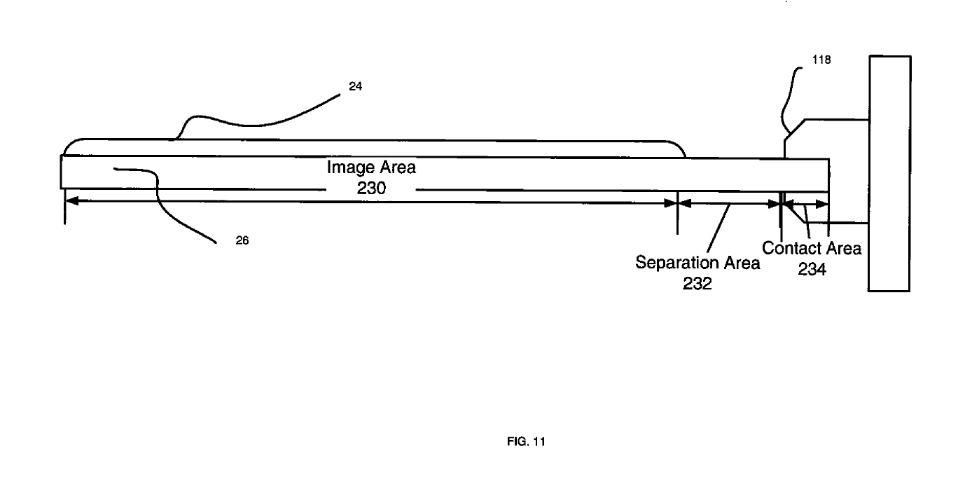

The heat applied by fused toner 24 to sheets 112 will typically be insufficient to locally raise the temperature of a sheet 112 to a temperature that can fuse a toner 24 applied to a sheet 112 to form an image. However, to provide additional protection against the risk that toner 24 applied for forming an image on a sheet 112 will be fused by heat applied to sheet 112 by fused toner 24, in one embodiment illustrated in FIG. 11, printer controller 82 can cause toner 24 to be arranged for image formation on a sheet 112 within an image area 234 that is separated by a separation area 232 from a contact area 230 that is in contact with fused toner 24 in the binding area 118. The separation area 232 is defined so that it does not allow heat from the heated toner 24 in binding area 118 to cause toner 24 in the image area to fuse.

In particular it will be appreciated that at least a portion of heat from fused toner 24 in binding area 118 will heat sheet 112 in areas beyond contact area 230 including separation area 232. Heating of separation area 232, in turn, can cause heating of image area 234. In the embodiment illustrated here, separation area 232 comprises air and portions of receiver 26 between contact area 230 and image area 234. Heat from fused toner 24 in binding area 188 is absorbed by the materials in separation area 232, heating separation area 232 and causing the temperature of receiver 26 in separation area 232 to rise. The materials in separation area 232 optionally also emit heat that can be absorbed into the environment surrounding sheet 112.

The absorption and optionally, emission of heat by materials such as receiver 26 in separation area 232 act to reduce the amount of heat reaching image area 234 such that separation area 232 does not heat image area 234 to an extent sufficient to fuse toner 24 in image area 234 and allow receiver 26 to protect toner 24 in image area 234 from being fused heated by heat 134.

For example, in one embodiment, receiver 26 in separation area 232 has sufficient thermal capacity to absorb enough to allow the separation area 232 to heat without heating image area 234 to an extent that causes toner 24 in image area 234 to fuse. In another embodiment, receiver 26 in separation area 232 has sufficient thermal absorption capacity to absorb coupled with sufficient capacity to emit enough of the heat from toner 24 in separation area 232 to heat without heating image area 234 to cause toner 24 in image area 234 to fuse. Receiver 26 in separation area 232 can emit heat using for example, radiation, convection, or conduction.

In certain embodiments, controller 82 can determine a size of separation area 232 based upon at least one of the thermal transfer characteristics of receiver 26 in separation area 232, the thermal emission characteristics of receiver 26 in separation area 232, the thermal conductivity of the receiver 26, the thermal characteristics of an environment surrounding the receiver 26 in the separation area 232, and the amount of toner 24 in contact with sheet 112.

Accordingly, providing separation area 232 between contact area 230 and image area 234 a sufficient amount of heat can be provided to fuse toner 24 in binding area 118 without fusing toner 24 in image area 112 for a second time.

The invention has been described in detail with particular reference to certain preferred embodiments thereof, but it will be understood that variations and modifications can be effected within the spirit and scope of the invention.

### PARTS LIST

20 printer
22 print engine
24 toner
25a toner image
25b toner image
25c toner image
25d toner image
26 receiver
28 receiver transport
30 surface
32 receiver supply
36 motor
38 rollers
40 printing station
42 printing station
44 printing station
46 printing station
48 printing station
50 transfer subsystem
52 cleaning mechanism
60 fuser
70 print
70a print
70b print
70c print
70d print
80 automatic folding system
82 controller
84 user input system
86 sensors
88 memory
90 communication system
92 external device(s)
94 output system
100 Binding system
102 Stacking system
104 Heater
106 Positioning system
108 Binding system controller
110 Stack
111 Stack height
112 Sheet
113 Binding edge
114 Stacking area
116 Outer print
118 Binding area
119 Leading edge
120 Stack positioning system
122 Stack support wall
124 Gravity
126 Alignment surface
128 Alignment surface actuator
130 Pressure surface
132 Pressure surface actuator
135 Stack advance actuator
139 Stack advance sensor
140 outer print positioning system
142 Outer print support surface
144 Outer print advance
146 Radial path
148 First pivot
149 Support Sensor
150 Second pivot
152 Fold surface
154 Edge
158 Gap
160 Print step
162 Step
164 Step
166 Step
170 Stack roller
172 Stack roller
174 Stack roller
176 Stack roller
178 Stack roller
180 Pressure roller
182 Outer print transport path
190 Outer print roller
192 Outer print roller
194 Outer print roller
198 First guide roller
200 Second guide roller
202 Guide surface
206 Motor
208 Diverter
210 First path
212 Second path
220 Engagement area
222 Sensor
230 Contact area
232 Separation area
234 Image area

What is claimed is:

1. A printing method comprising the steps of
printing an outer print having toner fused to a receiver in a binding area;
providing a plurality of sheets each having a binding edge;
heating the binding area so that toner in the binding area fuses; and
combining the fused toner in the binding area and the binding edges of the plurality of sheets and holding the binding edges in combination with the toner as the toner cools, so that the toner bonds the sheets to the outer print.

2. The printing method of claim 1, wherein the toner is applied in the binding area having a shape that is sized at least along one dimension based upon an estimated stack height of the toner.

3. The printing method of claim 1, wherein an image is provided in an image area on one of the prints and the image is provided in an image area that is separated by a separation area from a contact area that is in contact with the toner in the binding area and wherein the separation area does not allow heat from the heated toner to cause toner in the image area to fuse.

4. The printing method of claim 1, wherein the toner on the outer print is fused by the heating and then the combining is performed by pressing the fused toner into contact with the binding edges of the receiver.

5. The printing method of claim 1, wherein the toner on the outer print is fused by the heating and then the combining is performed by moving the stack to press the binding edges of the receiver.

6. The printing method of claim 1, wherein the binding edges of the sheets are applied against the toner in the binding area with a first pressure at a first position, with the pressure being selected to cause the binding edges to enter the toner and move to a second position when the toner is fused, and wherein movement of the binding edges is to the second position is sensed and wherein heat that is applied to fuse the toner in the binding area is discontinued based upon such sensed movement.

7. An electrophotographic printer comprising:
a print engine to form toner images on a plurality of sheets each sheet having a binding edge and to provide toner in a binding area on an outer print;
a fuser for applying a fusing heat to fuse the toner applied to the sheets and fuse the toner applied to the outer print;
a stacking system having a stacking area in which the plurality of sheets can be stacked with a binding edges along a side of the stack a positioning system that positions the outer print and stack relative to each other; and
a heater heating a side of the outer print opposite from the toner in the binding area with sufficient heat to fuse the toner in the binding area for a second time,
wherein the positioning system causes the binding edges of the sheets to combine with the toner in the binding area while the toner in the binding area is fused and holds the sheets and the toner in the binding area in combination while the toner in the binding area cools so that toner in the binding area can form a bond between the sheets and the outer print.

8. The printer of claim 7, wherein the controller causes the print engine to form toner images on the sheets with toner arranged to form images on each sheet in an image area that is separated by a separation area from a contact area of the sheet that is in contact with the toner used for binding and wherein the separation area do not transfer enough heat from the contact area to the image area during the heating of the toner in the binding area to fuse the toner in the image area.

9. The printer of claim 7, wherein the toner is applied in the binding area having a shape that is sized at least along one dimension based upon an estimated stack height of the sheets that will be in the stack when printed.

10. The printer of claim 7, wherein the toner is applied in the binding area having a pattern that is determined based upon an estimated stack height of the sheets that will be in the stack when printed.

11. The printer of claim 7, wherein after the step of heating causes the toner on the outer print to be fused and the positioning system uses an outer print positioning system having an outer print support surface to hold the outer print and an outer print actuator to move the outer print to press the fused toner into contact with the binding edges.

12. The printer of claim 7, wherein the positioning system uses an outer print positioning system having an outer print support surface to support the outer print and an outer print actuator to drive the outer print support surface to press the toner in the binding area against the binding edges and wherein the heater is positioned to heat outer surface from a side opposite from a side having the toner the binding area after the binding area is positioned with toner in the binding area in contact with the binding edges.

13. The printer of claim 7, wherein the toner on the outer print is fused and then the positioning system uses a stack positioning system to hold the stack and to move the stack so that the binding edges are pressed into contact with the fused toner in binding area before heat is applied.

14. The printer of claim 7, wherein the positioning system uses a stack positioning system to hold the stack and to move the stack so that the binding edges are pressed with a first pressure against the toner in binding area before the toner in the binding area is fused, and wherein the toner in the binding area allows the stack to move to a first position when the toner is unfused and the toner in the binding area allows the stack to be moved to a second position when the toner is fused.

15. The printer of claim 14, wherein the positioning system further comprises a sensor that senses a condition from which the controller can determine that the stack has been moved to the second position and wherein the controller discontinues heating of the when the stack is moved to the second position.

16. The printer of claim 14, wherein the positioning system further comprises a sensor that senses a condition from which the controller can determine that the stack has been moved to from the first position toward the second position and wherein controller can discontinues heating of the toner in the binding area based upon the detected movement of stack from the first position toward the second position.

17. The printer of claim 12, wherein the pressure of the unfused toner in the binding area against the binding allows the outer print actuator to position the outer print at a first position relative to the binding edges when the toner in the binding area is unfused, and a second position relative to the binding edges when a the toner is fused, and wherein the system further comprises a sensor to detect when the outer print is moved to the second position and the controller ceases heating of the outer print in response to detected movement.

18. A printer comprising:
a means for providing a plurality of sheets;
a means for printing an outer print having a toner image with a binding area fused to a receiver;
a means for heating the binding area so that toner in the binding area fuses for a second time; and
a means for combining the heated toner in the binding area and binding edges of the plurality of sheets and holding the binding edges in combination with the toner until the toner cools, so that the toner bonds the sheets to the outer print.
